(19) United States
(12) Patent Application Publication
(10) Pub. No.: US 2004/0115373 A1
(43) Pub. Date: Jun. 17, 2004

(54) Display table for artificial flowers and other objects

(76) Inventors: Peggy Dancer, Kingwood, TX (US); Steve Dancer, Kingwood, TX (US)

Correspondence Address: Andrew DiNovo, 4021 Walnut Clay Dr., Austin, TX, 78731, US

(21) Appl. No.: 10/319,793

(22) Filed: Dec. 14, 2002

(51) Int. Cl. B32B 1/02

(52) U.S. Cl. 428/34.1; 428/137

(57) ABSTRACT

The invention relates to a new display table for artificial flowers and other objects and a method for fabricating the table. The table comprises at least three tiers, and has disposed within it cutouts for receiving cans. The cans may be formed with a lip so that they rest within the cutouts. The cans are used to hold the artificial flowers. Optionally, the display table may feature a metal rim that can be used to facilitate the display of additional items.

### FIELD OF THE INVENTION

The invention generally relates to the field of product displays, and more particularly to a display table for artificial flowers and other display objects and a method of providing for the display of artificial objects and flowers in a retail environment.

### RELATED ART AND SUMMARY OF INVENTION

The retail sale of artificial or “silk” flowers is a thriving and growing market. One problem associated with the market is how best to display the many different products that are available to retailers. While the market has grown, the options available to retailers desiring to display and sell such products has remained relatively stagnant.

Prior art approaches to the display problem have been historically directed to cardboard pop up displays, which are not particularly durable or aesthetically pleasing. Our design clearly provides a more permanent solution as well as the ability to display more items in a smaller area. The largely two-dimensional cardboard displays with “punch-outs” allow for particular products to be inserted therein. While such prior art solutions are functional, they fail from at least two perspectives: aesthetics and durability. Accordingly, a new display system is desired.

Further features and advantages of the invention will appear more clearly from a reading of the detailed description of the preferred embodiments of the invention, which are given below by way of example only,, and with reference to the accompanying drawings, in which like references indicate similar elements, and in which:

### BRIEF DESCRIPTION OF THE DRAWINGS

FIG. 1 is a diagram of an embodiment of the display table of the present invention;

FIG. 2 is a diagram of the table of FIG. 1, further including a metal edge around the first tabletop;

FIG. 3 is the diagram of FIG. 1, further showing cans inserted into the second and third tabletops;

FIG. 4 is the diagram of FIG. 3, further showing cans inserted into the first tabletop and a metal edge around the first tabletop;

FIG. 5 is a top view of an embodiment of the display table of the present invention;

FIG. 6 is a top view of an embodiment of the display table of the present invention as shown in FIG. 5, but further including a metal edge around the first tabletop;

FIG. 7 is a side view of an embodiment of the display table of the present invention;

FIG. 8 is a side view of an embodiment of the display table of the present invention as shown in FIG. 9, but further including a metal edge around the first tabletop; and

FIG. 9 is a bottom view diagram of an embodiment of the display table of the present invention.

### DESCRIPTION OF PREFERRED EMBODIMENTS

The table as depicted in the attached drawings is to be used specifically for the display of artificial flowers. In the embodiment shown, the table is a three-tier table providing for the display of artificial flowers on each level. In alternative embodiments, additional tiers or attachments may be provided. The table serves as a display for artificial flowers or other products to be sold in a retail environment—i.e., the sales presentation vehicle to entice retail buyers to buy the product displayed in and/or on the table.

Preferably, in each tier of the table 10, 20 and 30 is disposed a series of cutouts 11, 21 and 31. In one embodiment, the cutouts 11, 21 and 31 are 4″ holes on the bottom level tabletop. The holes on the middle and tabletops are 8″ and are located around the circumference of each tabletop 10, 20 and 30. The variation allows the display of different types and/or quantities of sales articles. In the highest tabletop 30, which will usually be the smallest, as shown in FIG. 1, there may be a single row of cutouts 31.

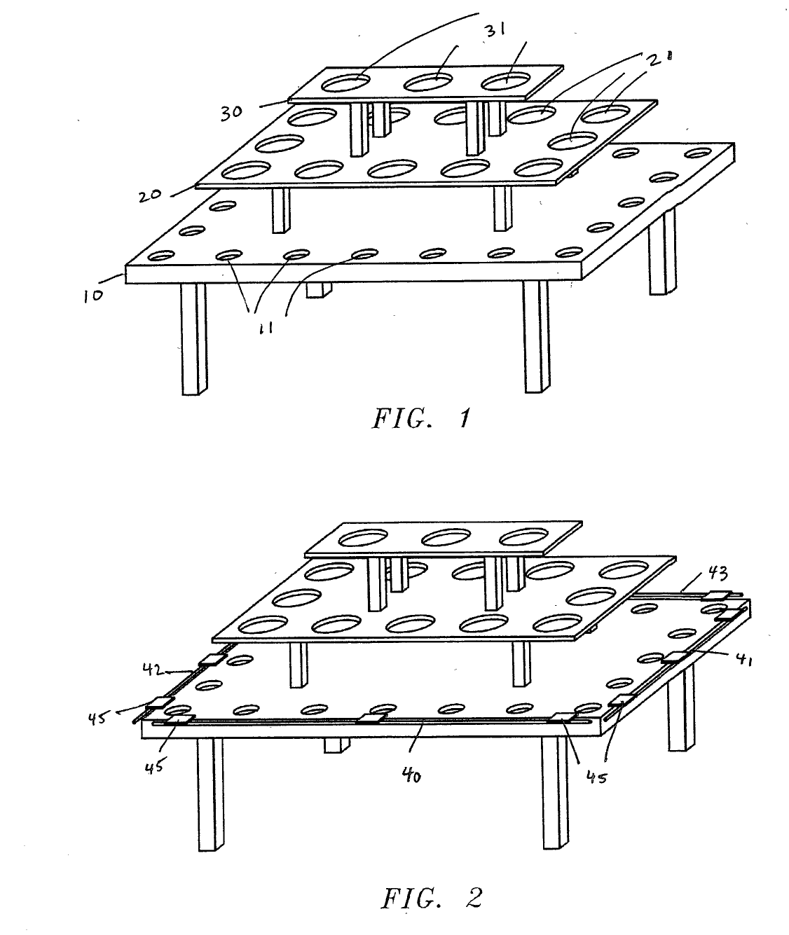

In yet another embodiment, depicted in FIG. 2, there are metal edges 40, 41, 42 and 43 fitted to the outside perimeter of at least the first tabletop 10. The metal edges 40, 41, 42 and 43 may be used is a display tool for displaying a certain type of artificial floral or other decoration. The metal edges 40, 41, 42 and 43 slightly elevated above the tabletop of the first tier to allow fasteners to be easily connected. The metal edges are shown in FIG. 2 connected to first tabletop 10 by brackets 45.

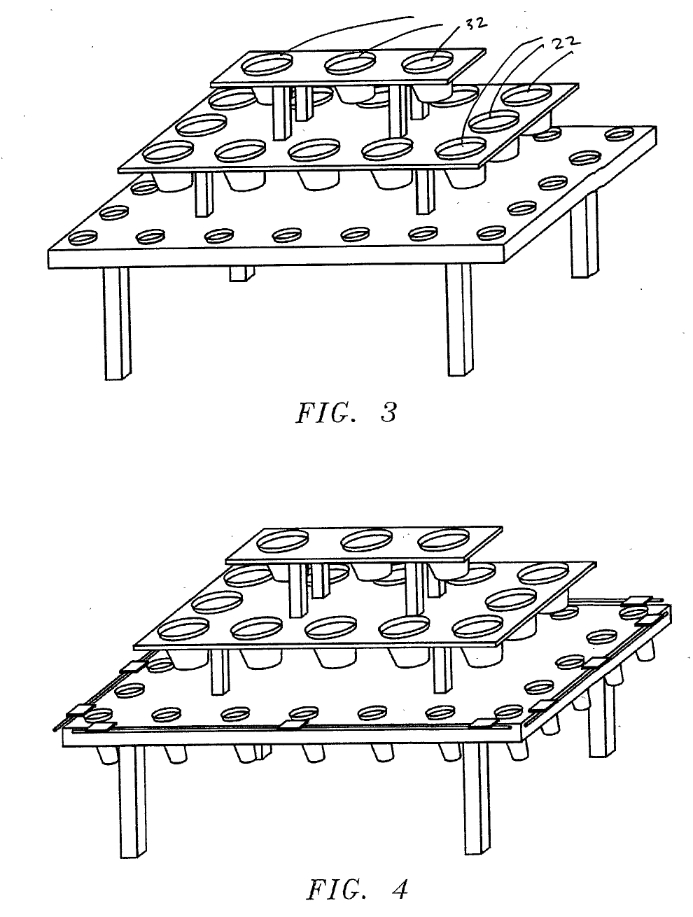

In FIG. 3, cutout holes 21, 31 on the second and third tabletops 20, 30 are shown with galvanized metal cans 22, 32 designed to fit directly into-each hole. The cans 22, 32 have a lip that, upon insertion into the cutouts 21, 31, is slightly elevated above the top edge of the tabletop. The cans serve as the display holder of the artificial flowers. As shown in FIG. 4, the cans can be of different sizes corresponding to different size cutouts as may be desired for various applications.

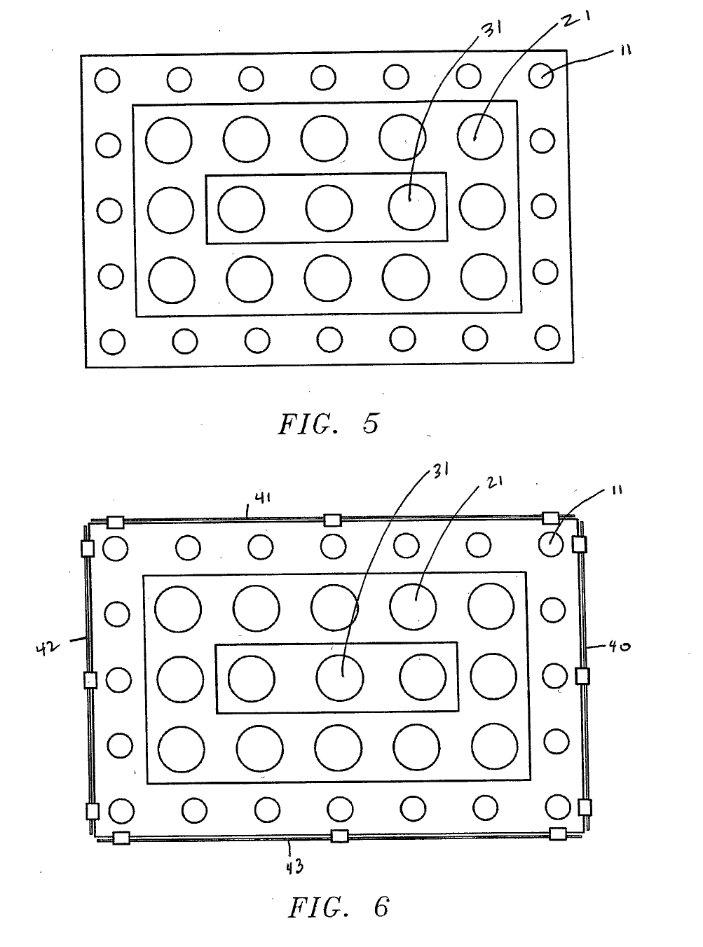

FIG. 5 shows a top view of an embodiment of the present invention. From the top view, the circular cutouts 21, 31 and 41 may clearly be seen. While the cutouts shown are round, other shapes may be used. FIG. 6 shows a top view, as in FIG. 5, and further including the optional metal edges 40, 41, 42 and 43.

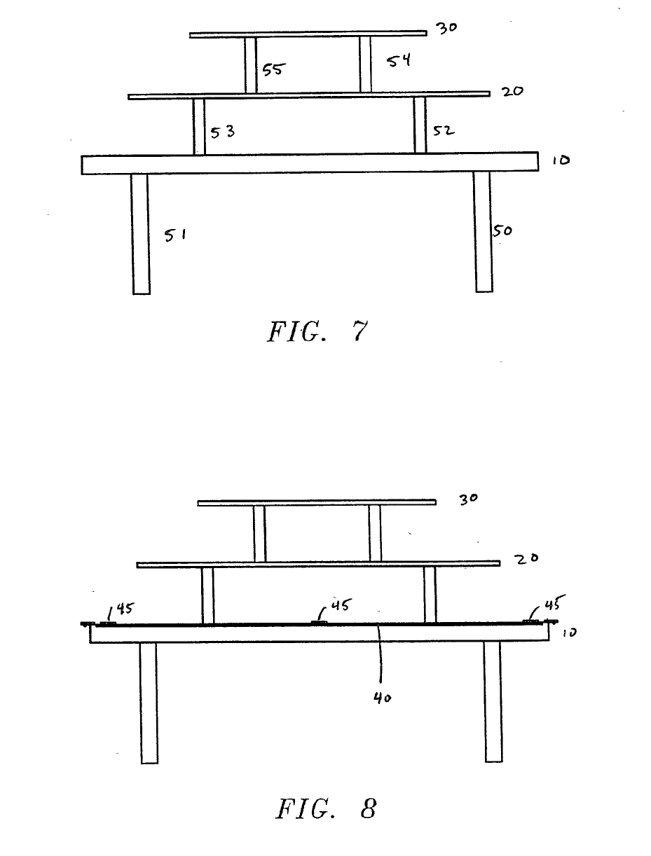

FIG. 7 shows a side view of an embodiment of the present invention. The side view clearly shows the three tabletops 10, 20, and 30, along with vertical support structures 50, 51; 54, 55; and 56, 57. In FIG. 8 is shown the side view and further metal edge 40 and support brackets 45.

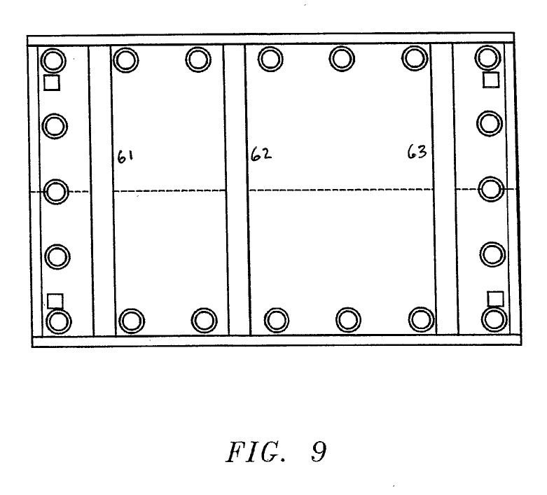

FIG. 9 shows a bottom view of an embodiment of the present invention. Visible are the underside of tabletop 10; vertical supports 50, 51, 52 and 53; and lateral supports 61, 62 and 63.

In a preferred embodiment, the table is manufacture of a combination of pressed wood and metal. The pressed wood may be a compressed mfp board, which allows easy cutting of the holes and is inexpensive to manufacture. Mfp board is a wood by-product. Those of skill in the art will recognize that the table may be constructed of other materials, such as wood, plastic, metal or composites.

In an embodiment of the method of the present invention, the table is made and shipped in a “knock-down” fashion. “Knock-down” refers to the method of shipping and assembly in which the parts are not completely assembled when shipped, and assembly instructions may be provided inside the shipping container. This significantly saves on the cost of freight. In this embodiment, specific assembly instructions for each retailer to correctly assemble the table may be provided. Screws, other fasteners and other implements can be provided by the manufacturer for assembly purposes. The knock-down construction materials, instructions and fastener sets can be shipped to retailers for on-site assembly.

Although certain preferred embodiments of the present invention have been described above by way of example, it will be understood that modifications may be made to the disclosed embodiments without departing from the scope of the invention, which is defined by the appended claims. The benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A display table for artificial flowers comprising:
a first tabletop forming a first tier, wherein said first tabletop has a first set of cutouts disposed therein;
a first support downwardly depending from said first tabletop;
a second support projecting upwards from said first tabletop, and to which a second tabletop is attached, said second tabletop forming a second tier; and
a third support projecting upwards from said second tabletop, and to which a third tabletop is attached, said third tabletop forming a third tier.

2. The display table of claim 1, further comprising a metal rim along at least some of said first tabletop.

3. The display table of claim 2, further comprising a metal rim along at least some of said second tabletop.

4. The display table of claim 3, further comprising a metal rim along at least some of said third tabletop.

5. The display table of claim 1, further comprising cans inserted into said first set of cutouts.

6. The display table of claim 1, further comprising a second set of cutouts within said second tabletop.

7. The display table of claim 6, further comprising cans inserted into said second set of cutouts.

8. The display table of claim 6, further comprising a third set of cutouts within said third tabletop.

9. The display table of claim 8, further comprising cans inserted into said third set of cutouts.

10. The display table of claim 9, wherein at least some of said cans have lips that overlap the cutouts in which they are inserted.

11. The display table of claim 9, wherein said first, second and third tabletops are round.

12. The display table of claim 9, wherein said first, second and third tabletops are rectangular.

13. The display table of claim 9, wherein said cans are round.

14. The display table of claim 9, wherein said cans are rectangular.

15. A method comprising:
preparing a set of instructions for the assembly of a display table;
collecting fasteners necessary for the assembly of said display table shipping to a customer for assembly of said display table a group of items comprising:
a first tabletop for a first display tier, said first tabletop having a first set of cutouts formed therein;
a first support for said first tabletop;
a second tabletop for a second display tier;
a second support to support said second tabletop over said first tabletop;
a third tabletop for a third display tier;
a third support to support said third tabletop over said second tabletop;
said instructions; and
said fasteners.

16. The method of claim 15, wherein said shipping is done in a knock down fashion.

17. The method of claim 15, wherein said shipping step further comprises shipping a first metal rim for attaching along at least some of said first tabletop.

18. The method of claim 17, wherein said shipping step further comprises shipping a second metal rim for attaching along at least some of said second tabletop.

19. The method of claim 18, wherein said shipping step further comprises shipping a metal rim for attaching along at least some of said first tabletop.

20. The method of claim 15, wherein said shipping step further comprises shipping a first set of cans for inserting into said first set of cutouts.

21. The method of claim 20, wherein said second tabletop has a second set of cutouts formed therein, and wherein said shipping step further comprises shipping a second set of cans for inserting into said second set of cutouts.

22. The method of claim 21, wherein said third tabletop has a third set of cutouts formed therein, and wherein said shipping step further comprises shipping a third set of cans for inserting into said third set of cutouts.

23. The method of claim 20, wherein at least some of said first set of cans have lips that are designed to overlap the cutouts into which they are to be inserted.
